(19) United States
(12) Patent Application Publication
(10) Pub. No.: US 2008/0295721 A1
(43) Pub. Date: Dec. 4, 2008

(54) Printing apparatus, holding device, printing method and program

(75) Inventors: Katsuya Yamaguchi, Kyoto (JP); Katsuki Fukuyama, Kyoto (JP); Satoru Kiyohara, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 12/155,345

(22) Filed: Jun. 3, 2008

(30) Foreign Application Priority Data
Jun. 4, 2007 (JP) JP2007-147950
Jun. 4, 2007 (JP) JP2007-148066

(51) Int. Cl. B41F 21/00

(52) U.S. Cl. 101/474

(57) ABSTRACT

A printing apparatus for performing printing on printing base materials comprises a holding device for holding a plurality of printing base materials at the same time and an image forming part for forming an image on a plurality of printing base materials held by said holding device. The holding device comprises a base on which a plurality of printing base materials are placed at the same time and an arrangement reference part for positioning a plurality of printing base materials placed on the base in a direction orthogonal to a transfer direction of the printing base materials. The arrangement reference part has a plurality of reference members which come into contact with different ones out of the printing base materials.

### BACKGROUND OF THE INVENTION

1. Field of the Invention

The present invention relates to a technique to perform printing while accurately positioning a plurality of printing base materials or a technique to supply the printing base materials to a printing apparatus. As to the former, the present invention relates more particularly to a technique to accurately supply the printing base materials while reducing the operator's load.

2. Description of the Background Art

In a case of double-sided printing on a printing base material, for example, if an image is not printed (formed) on a precise position relative to the printing base material, the positions of the images on the front and back surfaces are misaligned, and this remarkably deteriorates the quality of a printed matter. When it is desired to print an image on a precise position of a printing base material, it is important that the printing base material should be accurately positioned, an origin position of the image should be determined with respect to the positioned printing base material and then printing of the image should be started with reference to the determined origin.

Conventionally, methods of determining an origin position in printing have been proposed. Japanese Patent Application Laid Open Gazette No. 2000-177197 (Patent Document 1), for example, proposes a technique to perform printing while correcting an origin position depending on whether an image to be printed should be formed on a front surface or a back surface.

On the other hand, in a relatively large printing apparatus, when printing is performed on small-sized printing base materials one after another, the printing efficiency is remarkably deteriorated. Therefore, in a large-sized printing apparatus, in order to improve the printing efficiency, it is increasingly requested to perform printing operations parallelly on a plurality of printing base materials while arranging the printing base materials in parallel to a transfer direction.

In conventional printing apparatuses, however, there has been a problem that a plurality of printing base materials can not be positioned accurately. If the printing base materials are not accurately positioned, the image can not be formed on a precise position even if the technique shown in Patent Document 1 is adopted.

Further, even the technique shown in Patent Document 1 does not conceive the printing on a plurality of printing base materials and has a problem that the image can not be printed on a precise position in a case of printing on a plurality of printing base materials.

Furthermore, well known is a printing apparatus which performs a printing operation on one printing base material in a plurality of times. For example, after performing printing on a front surface of the printing base material, the printing base material is once transferred out from the printing apparatus and then the printing base material is supplied again to the printing apparatus to perform printing on a back surface of the printing base material.

In the printing apparatus in which the printing base material is once transferred out before all the printing operation is completed, however, it is necessary to appropriately determine the orientation and position of the printing base material depending on the conditions of previous printing operations on the printing base material when the printing base material is supplied for the second or the following printing operations, and this disadvantageously imposes a load on an operator. Particularly, in conditions where there are many types of printing base materials or a lot of patterns of printing operations (double-sided printing, plural and simultaneous printing and the like), the operator's load increases and if a printing base material is wrongly supplied, the printing base material and time go to waste.

### SUMMARY OF THE INVENTION

It is a first object of the present invention to print an image on a precise position of each of printing base materials when a plurality of printing base materials are set for a printing operation.

It is a second object of the present invention to accurately supply printing base materials while reducing the operator's load.

In order to achieve the first object, the present invention is intended for a printing apparatus for performing printing on printing base materials. According to a first aspect of the present invention, the printing apparatus comprises a holding device for holding a plurality of printing base materials at the same time, and an image forming part for forming an image on the plurality of printing base materials held by the holding device, and in the printing apparatus, the holding device comprises a base on which a plurality of printing base materials are placed at the same time, and an arrangement reference part for positioning the plurality of printing base materials placed on the base in a direction orthogonal to a transfer direction of the printing base materials, and the arrangement reference part has a plurality of reference members which come into contact with different ones out of the plurality of printing base materials.

Since it thereby becomes possible to position each of the printing base materials, the positioning accuracy can be improved. Therefore, it is possible to form an image on a precise position.

In order to achieve the first object, the present invention is also intended for a holding device for holding a plurality of printing base materials at the same time. According to a second aspect of the present invention, the holding device comprises a base on which a plurality of printing base materials are placed at the same time, and an arrangement reference part for positioning the plurality of printing base materials placed on the base in a direction orthogonal to a transfer direction of the plurality of printing base materials, and in the holding device, the arrangement reference part has a plurality of reference members which come into contact with different ones out of the plurality of printing base materials.

Since it thereby becomes possible to position each of the printing base materials, the positioning accuracy can be improved. Therefore, it is possible to form an image on a precise position.

In order to achieve the first object, the present invention is further intended for a printing method of forming an image while holding a plurality of printing base materials. According to a third aspect of the present invention, the printing method comprises the steps of (a) placing a plurality of printing base materials on a base, (b) bringing the plurality of printing base materials placed on the base into contact with different reference members and positioning the plurality of printing base materials in a direction orthogonal to a transfer direction of the printing base materials, and (c) forming an image on the plurality of printing base materials positioned on the base.

Since it thereby becomes possible to position each of the printing base materials, the positioning accuracy can be improved. Therefore, it is possible to form an image on a precise position.

In order to achieve the second object, the present invention is intended for a printing apparatus for printing an image on a printing base material. According to a fourth aspect of the present invention, the printing apparatus comprises a storage part for storing printing material information for each printing base material, a search part for searching the storage part for the printing material information of a printing base material to be supplied to the printing apparatus on the basis of identifying information for identifying the printing base material, a generation part for generating supply information of the printing base material in accordance with a search result of the search part, an output part for outputting the supply information generated by the generation part, and an image forming part for forming an image on the printing base material.

By performing a supply operation in accordance with the outputted supply information, it is possible to supply the printing base material while preventing any mistake. Therefore, the load of supplying the printing base material can be reduced.

In order to achieve the second object, the present invention is also intended for a printing method for printing an image on a printing base material by a printing apparatus. According to a fifth aspect of the present invention, the printing method comprises the steps of (a) acquiring identifying information for identifying a printing base material on which an image is formed by the printing apparatus, (b) searching a storage part for printing material information of the printing base material in accordance with the identifying information, (c) generating supply information of the printing base material when the printing material information of the printing base material is found in the step (b), (d) outputting the supply information generated in the step (c), (e) supplying the printing base material to the printing apparatus, (f) forming an image on the printing base material supplied to the printing apparatus in the step (e), and (g) storing the printing material information of the printing base material into the storage part.

By performing a supply operation in accordance with the outputted supply information, it is possible to supply the printing base material while preventing any mistake. Therefore, the load of supplying the printing base material can be reduced.

In order to achieve the second object, the present invention is further intended for a program product capable of being executed by a computer. According to a sixth aspect of the present invention, execution of the program product by the computer causes the computer to function as a storage part for storing printing material information for each printing base material, a search part for searching the storage part for the printing material information of a printing base material to be supplied on the basis of identifying information for identifying the printing base material, a generation part for generating supply information of the printing base material in accordance with a search result of the search part, and an output part for outputting the supply information generated by the generation part.

By performing a supply operation in accordance with the outputted supply information, it is possible to supply the printing base material while preventing any mistake. Therefore, the load of supplying the printing base material can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagrammatic perspective view showing a printing apparatus in accordance with a first preferred embodiment;

FIG. 2 is a diagrammatic perspective view showing a holding device and an image forming part of the printing apparatus;

FIG. 3 is a plan view showing a manner where two printing base materials are placed on the holding device;

FIG. 4 is a side elevation showing the manner where two printing base materials are placed on the holding device;

FIG. 5 is a block diagram showing a constitution of a control part;

FIG. 6 is a flowchart showing an operation flow of the printing apparatus;

FIG. 7 is a flowchart showing a detailed flow of printing operation;

FIG. 8 is a view showing a data buffer of a printing head;

FIG. 9 is a view showing a manner where an image is formed on the two printing base materials;

FIG. 10 is a functional block diagram showing a printing apparatus in accordance with a second preferred embodiment;

FIG. 11 is a flowchart showing an operation flow in accordance with the second preferred embodiment;

FIG. 12 is a view illustrating a screen displaying information on a selected job;

FIGS. 13 to 15 are views each illustrating a screen displaying instructions in placement of printing base materials;

FIGS. 16 and 17 are views each showing a variation of drawing order of the printing head;

FIG. 18 is a diagrammatic perspective view showing a printing apparatus in accordance with a third preferred embodiment;

FIG. 19 is a plan view showing a manner where two printing base materials are placed on a holding mechanism at the same time;

FIG. 20 is a side elevation showing the manner where two printing base materials are placed on the holding mechanism at the same time;

FIG. 21 is a bus wiring diagram of the printing apparatus;

FIG. 22 is a view illustrating a data structure of printing material information;

FIG. 23 is a view showing a functional block of a control part together with data flow;

FIGS. 24 and 25 are flowcharts showing a printing method using the printing apparatus;

FIG. 26 is a view illustrating an example of job list selection screen displayed on a display part; and

FIG. 27 is a view illustrating a screen displaying supply information.

### DESCRIPTION OF THE PREFERRED EMBODIMENTS

Hereinafter, the preferred embodiments will be discussed in detail with reference to accompanying drawings.

### 1. The First Preferred Embodiment

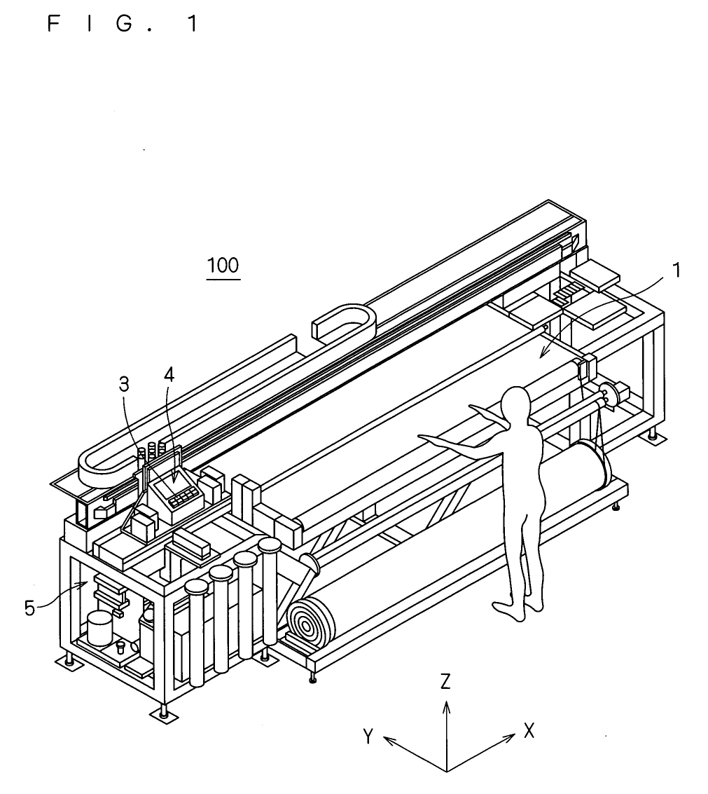

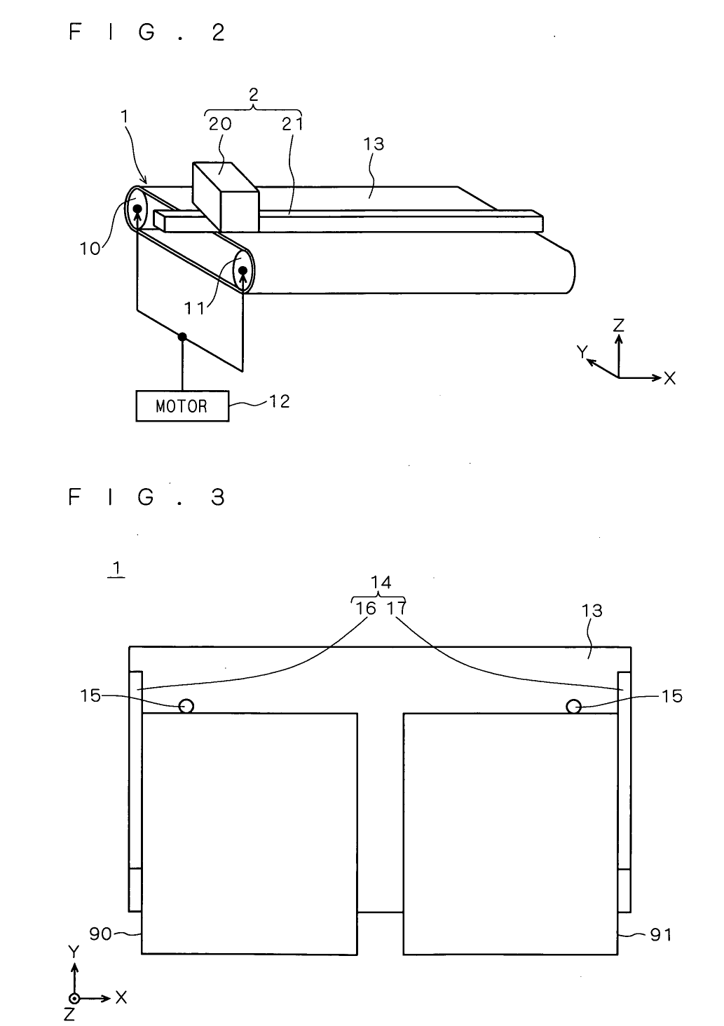

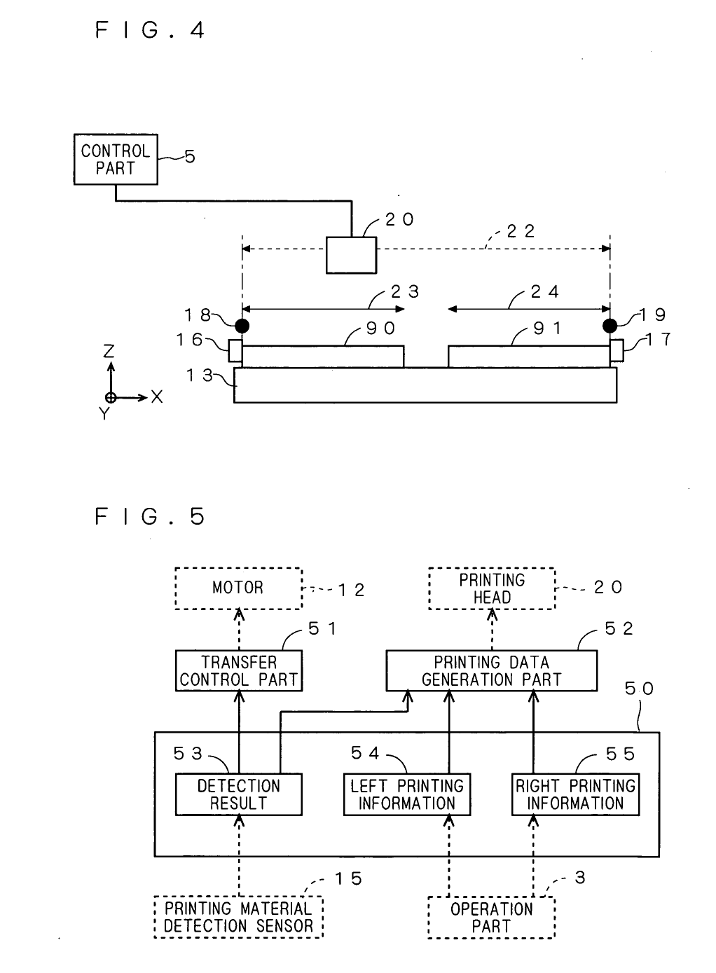

FIG. 1 is a diagrammatic perspective view showing a printing apparatus 100 in accordance with the first preferred embodiment. FIG. 2 is a diagrammatic perspective view showing a holding device 1 and an image forming part 2 of the printing apparatus 100. FIG. 3 is a plan view showing a manner where two printing base materials 90 and 91 are placed on the holding device 1, and FIG. 4 is a side elevation showing the manner where two printing base materials 90 and 91 are placed on the holding device 1.

In FIG. 1, though the Z-axis direction is a vertical direction and the XY plane is a horizontal plane for convenience of illustration and discussion, they are defined so for convenience to grasp the positional relation and the directions discussed below are not limited to those. The same applies to the following figures. Further, in FIG. 1, an enclosure of the printing apparatus 100 is omitted as appropriate. A transfer direction of the printing base materials in the printing apparatus 100 is a direction along the Y axis. The printing base materials 90 and 91 used in the printing apparatus 100 are not limited to paper but may be cloth, a panel or the like, and not limited to have a rectangular shape but may be rolled up.

The relatively large printing apparatus 100 comprises the holding device 1, the image forming part 2, an operation part 3, a display part 4 and a control part 5. The holding device 1 comprises a pair of transfer rollers 10 and 11, a motor 12, an adsorption belt 13, an arrangement reference part 14 and a printing material detection sensor 15, and is capable of holding the two printing base materials 90 and 91 at the same time as shown in FIG. 3.

The transfer roller 10 disposed on the (+Y) side and the transfer roller 11 disposed on the (−Y) side are cylindrical members with the X-axis direction as a longitudinal direction, and a driving force of the motor 12 is conveyed thereto through a not-shown link member. Specifically, the transfer rollers 10 and 11 are rotated about the X axis as a central axis by the motor 12. The driving force of the motor 12 may be conveyed to either one of the transfer rollers 10 and 11. In other words, one of the transfer rollers 10 and 11 may function as a driving roller and the other may function as a follower roller.

The motor 12 is a servomotor capable of easily controlling the rotation speed, the amount of rotation and the rotation direction in accordance with a control signal from the control part 5 and generates a rotation driving force for rotating the transfer rollers 10 and 11 as discussed earlier.

The adsorption belt 13 runs between the transfer rollers 10 and 11. An upper side of the adsorption belt 13 is a plane on which the printing base materials in parallel to the XY plane can be placed. In other words, the adsorption belt 13 is an exemplary constituent which mainly corresponds to a base of the present invention. The adsorption belt 13 of the first preferred embodiment has a size of about 2.5 m in the X-axis direction, thereby allowing a relatively large printing base material to be placed thereon.

Further, the adsorption belt 13 is provided with an infinite number of holes which are not shown and thereby has a function to adsorb the printing base materials placed thereon to hold them. Specifically, the transfer rollers 10 and 11 are rotated by the motor 12 in a predetermined direction and the adsorption belt 13 is thereby rotated to transfer the printing base materials held on the adsorption belt 13 in the Y-axis direction (transfer direction).

The arrangement reference part 14 has a left guide member 16 and a right guide member 17. Though discussed later, the arrangement reference part 14 has a function to position a plurality of printing base materials placed on the adsorption belt 13 in a direction (X-axis direction) orthogonal to the transfer direction (Y-axis direction) of the printing base materials.

The left guide member 16 and the right guide member 17 are separately disposed and fixed on both sides along the transfer direction so as to be positioned on desired positions in the X-axis direction with respect to the adsorption belt 13. In other words, the left guide member 16 and the right guide member 17 are fixed oppositely to each other in the X-axis direction and the printing base materials transferred by the adsorption belt 13 pass (are transferred) between the left guide member 16 and the right guide member 17.

The left guide member 16 and the right guide member 17 come into contact with different ones out of a plurality of printing base materials. In more detail, the left guide member 16 comes into contact with the left side end of the printing base material 90 placed on the left side and the right guide member 17 comes into contact with the right side end of the printing base material 91 placed on the right side.

With this arrangement, the printing base material 90 is positioned by the left guide member 16 in the X-axis direction with reference to the position of a left origin 18 in the X-axis direction as shown in FIG. 4. The printing base material 91 is positioned by the right guide member 17 in the X-axis direction with reference to the position of a right origin 19 in the X-axis direction as shown in FIG. 4. In other words, the left guide member 16 and the right guide member 17 are exemplary constituents which mainly correspond to reference members of the present invention.

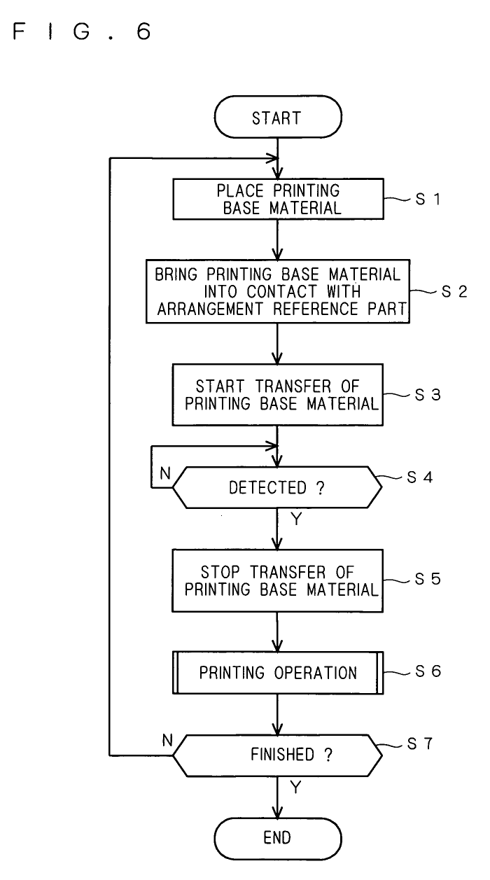

The printing material detection sensor 15 schematically shown in FIG. 3 is actually disposed above the adsorption belt 13 and detects that the printing base material placed on the adsorption belt 13 reaches a desired position in the Y-axis direction. A detection result 53 of the printing material detection sensor 15 (in FIG. 5) is transmitted to the control part 5 and then used for control of the motor 12 and the like, as discussed later in detail.

As the printing material detection sensor 15 used are a CCD sensor which makes a judgment by picking up an image of a tip portion of the printing base material or a non-contact sensor such as a laser sensor or the like, which makes a judgment by detecting that projected laser is shielded or reflected. Further, a contact sensor which makes a judgment by detecting a pressure in making contact with a printing base material, or the like may be adopted.

The image forming part 2 shown in FIG. 2 comprises a printing head 20 and a printing head moving part 21.

The printing head 20 forms an image on the printing base materials 90 and 91 held by the holding device 1 on the basis of the control of the control part 5. Though the printing head 20 of the first preferred embodiment adopts an inkjet system using a UV ink, naturally, the printing head 20 is not limited to that. Further, the number of printing head 20 is not limited to one.

The printing head 20 is movable to and fro in the X-axis direction by a not-shown driving mechanism along the printing head moving part 21. As the printing head 20 moves in the X-axis direction, an area indicated by the broken-line arrow 22 is a drawing area (an area in which an image can be formed) of the printing head 20.

As can be clearly seen from FIG. 4, the drawing area of the printing head 20 indicated by the broken-line arrow 22 is so set as to include respective drawing areas of the printing base materials 90 and 91 which are indicated by the solid-line arrows 23 and 24. Therefore, the printing head 20 can form an image on each of the printing base materials 90 and 91 placed at the same time.

Further, as discussed earlier, since the printing base materials are moved in the Y-axis direction by the adsorption belt 13, the printing head 20 can discharge ink onto any position of the printing base materials (more specifically, any position in the XY plane).

The operation part 3 consists of various buttons, keys, a mouse, a touch panel and the like and is manipulated by an operator in order to input instructions to the printing apparatus 100.

The display part 4 corresponds to a general-type liquid crystal display (LCD), lamp and the like and is controlled by the control part 5 to display various data to the operator.

FIG. 5 is a block diagram showing a constitution of the control part 5. The control part 5 comprises a CPU, a ROM and a RAM used as a temporary working area of the CPU, which are not shown. The control part 5 further comprises a plurality of functional blocks implemented by an operation of the CPU in accordance with a program stored in the ROM. These functional blocks are a transfer control part 51 and a printing data generation part 52 shown in FIG. 5.

The transfer control part 51 has a function to control the motor 12 in response to the detection result 53 acquired from the printing material detection sensor 15. A specific control operation of the transfer control part 51 will be discussed later.

The printing data generation part 52 has a function to start a printing operation of the printing apparatus 100 in response to the detection result 53 and generate printing data to be transmitted to the printing head 20 on the basis of left printing information 54 and right printing information 55 which are inputted from the operation part 3.

The printing data generation part 52 has a further function to specify either one of the side ends of each printing base material as a reference side end on the basis of a placement position of the printing base material on the adsorption belt 13 (for example, on the left side or the right side). A specific control operation of the printing data generation part 52 will be discussed later.

The above is discussion on the constitution and function of the printing apparatus 100 of the first preferred embodiment. Next, discussion will be made on an operation of the printing apparatus 100.

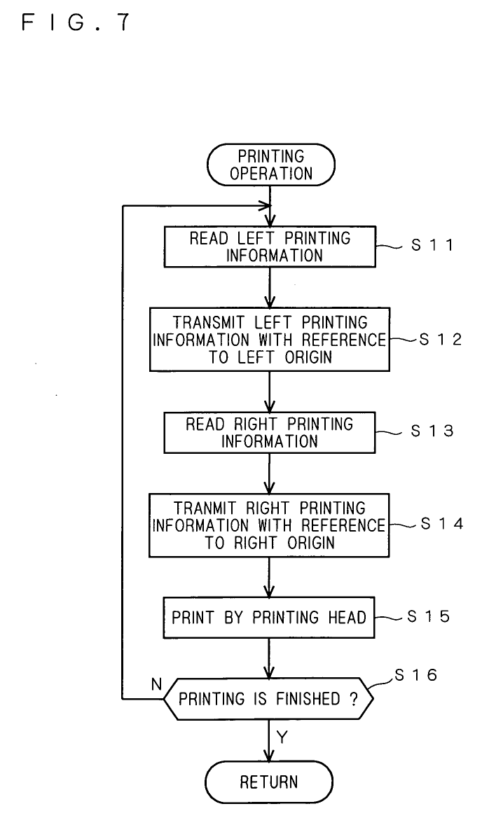

FIG. 6 is a flowchart showing an operation flow of the printing apparatus 100.

First, an operator places the printing base materials 90 and 91 on the adsorption belt 13 (Step S1). Step S1 may be executed by a non-shown transfer mechanism. If the printing base materials 90 and 91 are rolled-up type materials, Step S1 is executed by setting front and back rolls (feed roll and wind-up roll) in the printing apparatus 100.

The operator brings the printing base materials 90 and 91 into contact with the arrangement reference part 14 (Step S2) to position the printing base materials 90 and 91 in the X-axis direction. Specifically, the printing base material 90 is brought into contact with the left guide member 16 with its left side end being disposed along the guide member 16 and the printing base material 91 is brought into contact with the right guide member 17 with its right side end being disposed along the guide member 17.

Thus, since the printing apparatus 100 is provided with respective reference members (the left guide member 16 and the right guide member 17) for a plurality of printing base materials (the printing base materials 90 and 91), it can surely and accurately position a plurality of printing base materials.

Next, by manipulating the operation part 3, the operator inputs completion of the positioning in the X-axis direction to the printing apparatus 100. When this instruction is inputted, the transfer control part 51 controls the motor 12 to start rotation in the normal (positive) direction. The motor 12 thereby starts rotation in the normal direction to start transfer of the printing base materials 90 and 91 placed on the adsorption belt 13 in the (+Y) direction (Step S3).

The transfer of the printing base materials 90 and 91 continues until the printing material detection sensors 15 detect the tip portions of the printing base materials 90 and 91 on the (+Y) side (Step S4). Specifically, if the detection result 53 acquired from the printing material detection sensors 15 indicate that the printing base materials are detected (“Yes” in the Step S4), the transfer control part 51 controls the motor 12 to stop rotation and the transfer of the printing base materials 90 and 91 is thereby stopped (Step S5).

This means that the tip portions of the printing base materials 90 and 91 on the (+Y) side are present at the detection position (desired position) of the printing material detection sensor 15 and that the positioning of the printing base materials 90 and 91 in the Y-axis direction is made.

In parallel with the operation of Step S5 (i.e., in accordance with the detection result 53), the printing data generation part 52 starts a printing operation (Step S6). Further, in the first preferred embodiment, the adsorption belt 13 starts adsorption of the printing base materials 90 and 91 at this time.

FIG. 7 is a flowchart showing a detailed flow of the printing operation.

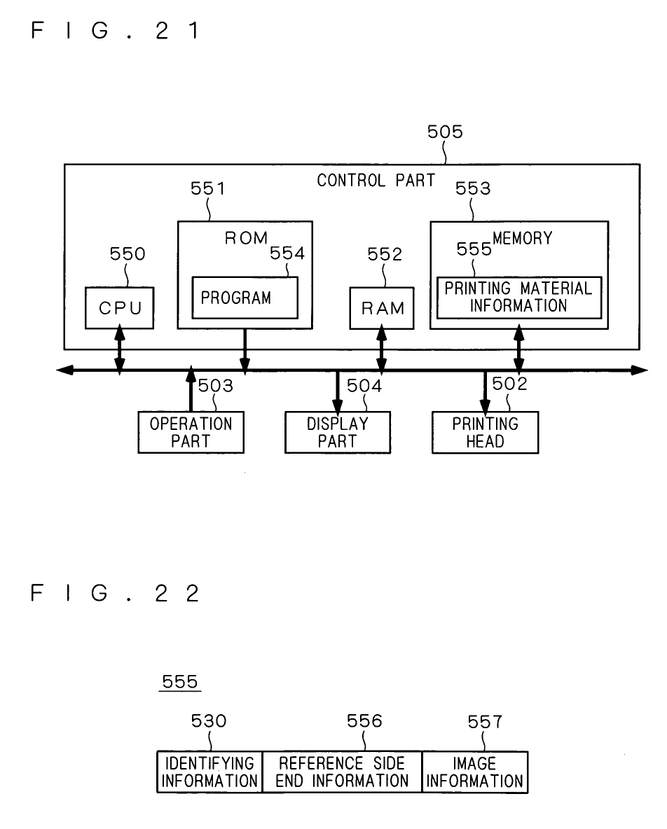

When the printing operation is started, the printing data generation part 52 reads the left printing information 54 indicating an image to be formed on the printing base material 90 out from the RAM 50 (Step S11) and transfers the information to a data buffer 25 of the printing head 20 (in FIG. 20) with reference to the left origin 18 (Step S12).

Next, the printing data generation part 52 reads the right printing information 55 indicating an image to be formed on the printing base material 91 out from the RAM 50 (Step S13) and transfers the information to the data buffer 25 of the printing head 20 with reference to the right origin 19 (Step S14).

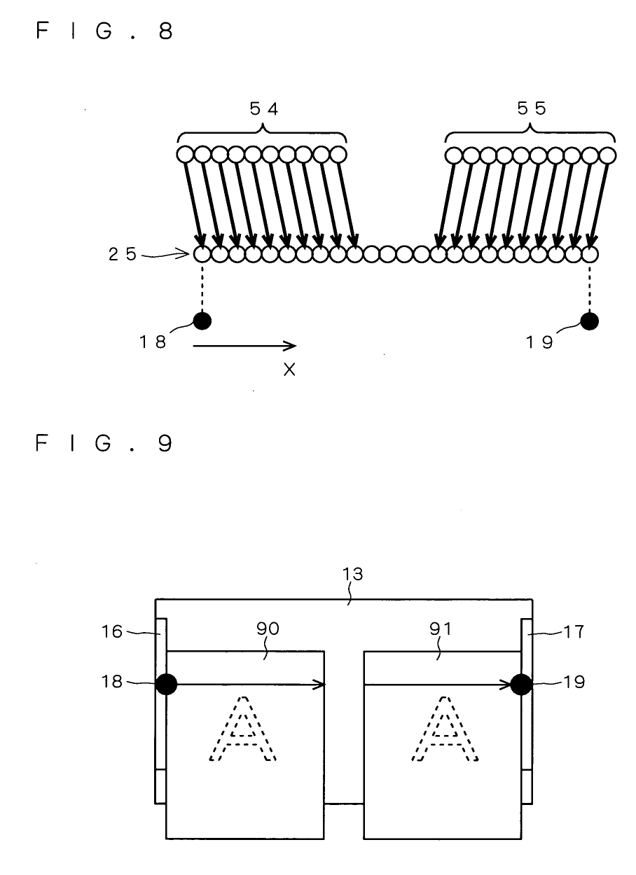

FIG. 8 is a view showing the data buffer 25 of the printing head 20. In FIG. 8, a blank circle indicates pixel data of one pixel.

The data buffer 25 of the printing head 20 can simultaneously store pixel data of one row in the X-axis direction in the drawing area of the printing head 20 (indicated by the broken-line arrow 22 in FIG. 4) so that the positional relation of the pixels in the drawing area can be made clear. In other words, the data buffer 25 has a construction of line buffer.

In FIG. 8, the number of pixels in the X-axis direction of the drawing area of the printing head 20 is “24” for simple illustration. Further, in the first preferred embodiment discussed will be an exemplary case where the pixel data is sequentially read out from one on the left end of the data buffer 25 shown in FIG. 8 toward another on the right end and the printing head 20 moves from the position of the left origin 18 toward the right origin 19 in the X-axis direction while drawing. Therefore, the pixel data on both ends in the data buffer 25 are the pixel data of the pixels positioned on the left origin 18 and the right origin 19.

In Step S11, the printing data generation part 52 reads out the pixel data of one row in the X-axis direction among the data of the left printing information 54. Then, in Step S12, the printing data generation part 52 transfers the pixel data of one row which is read out to the data buffer 25 so that the pixel data to be drawn on the leftmost position of the printing base material 90 among the pixel data of one row which is read out may become the pixel data on the left end of the data buffer 25. With this operation, the positional relation between the pixel data to be stored in the data buffer 25 and the pixel data in the left printing information 54 becomes one indicated by thick-line arrows of FIG. 8.

In Step S13, like in Step S11, the printing data generation part 52 reads out the pixel data of one row in the X-axis direction among the data of the right printing information 55. In Step S14, however, the printing data generation part 52 transfers the pixel data of one row which is read out to the data buffer 25 so that the pixel data to be drawn on the rightmost position of the printing base material 91 among the pixel data of one row which is read out may become the pixel data on the right end of the data buffer 25. With this operation, the positional relation between the pixel data to be stored in the data buffer 25 and the pixel data in the right printing information 55 becomes one indicated by thick-line arrows of FIG. 8.

Further, the pixel data on positions where no data is transferred from the left printing information 54 or the right printing information 55 (the pixel data in the center portion in FIG. 8) in the data buffer 25 are data indicating the pixels which does not form any image (the pixels on the positions to which the ink is not discharged).

Thus, the printing data generation part 52 forms the printing data of one row in the X-axis direction of the printing head 20 on the data buffer 25.

When the printing data is generated (Step S14 is executed), the printing head 20 moves from the left origin 18 toward the right origin 19 in the X-axis direction while printing an image of one row on the basis of the printing data stored in the data buffer 25 (Step S15). At this time, as discussed earlier, the pixel data stored in the data buffer 25 is sequentially read out from the pixel data on the left end.

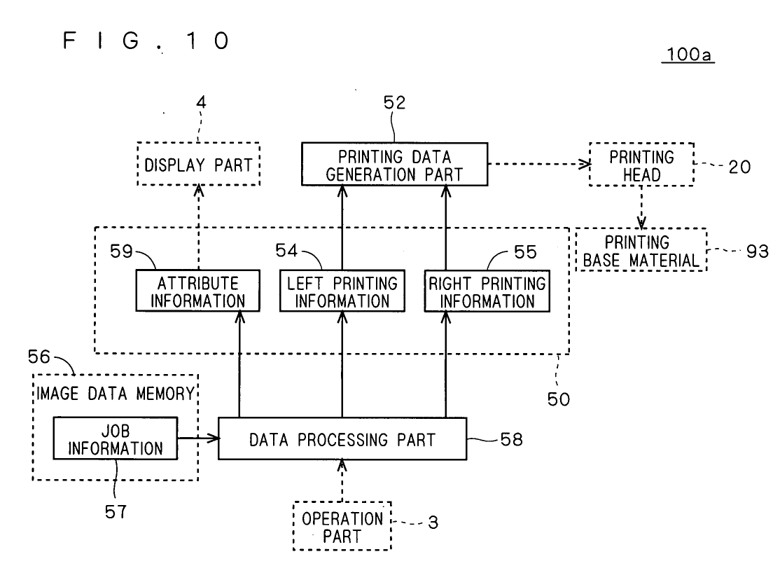

FIG. 9 is a view showing a manner where an image is formed on the two printing base materials 90 and 91. Since each image “A” is not formed yet at the time when the position indicated by the thick-line arrow is scanned, however, each image “A” is indicated by broken lines in FIG. 9.

As shown in FIG. 9, the left side end of the printing base material 90 placed on the left side comes into contact with the left guide member 16. Therefore, the control part 5 (the printing data generation part 52) specifies the left side end of the printing base material 90 as the reference side end and the image forming part 2 (the printing head 20) forms an image with reference to the left side end which is specified as the reference side end.

On the other hand, the right side end of the printing base material 91 placed on the right side comes into contact with the right guide member 17. Therefore, the control part 5 (the printing data generation part 52) specifies the right side end of the printing base material 91 as the reference side end and the image forming part 2 (the printing head 20) forms an image with reference to the right side end which is specified as the reference side end.

Since an image can be formed on each of the printing base materials with reference to its side end which serves as the positioning reference, the printing apparatus 100 can form an image on a precise position of each printing base material.

In the printing apparatus 100, since the two printing base materials 90 and 91 are individually positioned, the positioning accuracy for the printing base materials is improved as compared with the background-art techniques. There is a case, however, where expansion/contraction and the like might occur due to, e.g., heat and humidity. For example, though the position of the right side end of the printing base material 91 is always the right origin 19, i.e., a precise position, if expansion or contraction occurs in the printing base material 91, the position of the left side end is not precise. Therefore, when an image is formed on the printing base material 91 of this condition with reference to its left side end as the reference side end like on the printing base material 90, there is a possibility that the position of the image might not be precise.

In other words, in the printing apparatus 100, when a plurality of printing base materials are placed at the same time, since the reference side end is different depending on the position on which the printing base material is placed, there is a possibility that the position of the image might be disadvantageously misaligned if the image is formed with the reference side end being fixed like in the background art. Since the printing apparatus 100, however, individually specifies the respective reference side ends for the printing base materials 90 and 91, it can form an image on a precise position.

Referring back to FIG. 7, when Step S15 is executed, the printing apparatus 100 judges whether the printing operation is finished or not on all the rows in the X-axis direction of the left printing information 54 or the right printing information 55 (Step S16).

If the printing operation is not finished yet, the transfer control part 51 controls the motor 12 to rotate in the normal direction by a predetermined amount and the adsorption belt 13 thereby transfers the printing base materials 90 and 91 by one or more pixels in the (+Y) direction, to repeat this operation from Step S11. With this, the printing operation is repeated for the next one row.

On the other hand, if the printing operation is already completed, the operation is ended and the process returns to the operation of FIG. 6.

Further, when the printing operation of Step S6 is finished, the printing apparatus 100 judges whether the printing operation should be performed on other printing base materials or the operation should be ended (Step S7).

If it is instructed to further perform the printing operation on other printing base materials (“No” in Step S7), the process returns to Step S1 and the operation is repeated. On the other hand, it is instructed to end the operation (“Yes” in Step S7), the printing apparatus 100 ends the operation.

Thus, the printing apparatus 100 of the first preferred embodiment comprises the adsorption belt 13 on which a plurality of printing base materials 90 and 91 are placed at the same time and the arrangement reference part 14 for positioning the printing base materials 90 and 91 placed on the adsorption belt 13 in the direction (X-axis direction) orthogonal to the transfer direction of the printing base materials, and the arrangement reference part 14, which has a plurality of reference members (the left guide member 16 and the right guide member 17) which come into contact with different printing base materials 90 and 91, can individually position the printing base materials 90 and 91. Therefore, the positioning accuracy for the printing base materials 90 and 91 is improved and images can be formed on precise positions.

Further, since the respective side ends of the printing base materials 90 and 91 held by the holding device 1 which are in contact with the left guide member 16 and the right guide member 17 are individually specified as the reference side ends and the image forming part 2 forms images on the printing base materials 90 and 91 with reference to the respective reference side ends, it is possible to form images with reference to the respective side ends which serve as the positioning references of the printing base materials. Therefore, even if the side ends which serve as the positioning references are different depending on the printing base materials 90 and 91, it is possible to form images on respective precise positions of the printing base materials.

Furthermore, since the printing base materials 90 and 91 placed on the adsorption belt 13 are positioned by the printing material detection sensor 15 and the transfer control part 51 in the transfer direction (Y-axis direction) of the printing base materials, it is possible to form images on more precise positions.

Since the printing apparatus 100 further comprises the printing material detection sensor 15 for detecting that the positioning of a plurality of printing base materials 90 and 91 placed on the adsorption belt 13 is completed and the image forming part 2 (the printing head 20) starts formation of images in accordance with the detection result 53 of the printing material detection sensor 15, it is possible to start the printing operation after completion of the positioning without any operator's instruction.

By using the printing material detection sensor 15 for performing the positioning in the Y-axis direction also as a sensor for detecting that the positioning is completed, it is possible to reduce the cost. Though detailed discussion is omitted, in Step S4 of FIG. 6, the printing apparatus 100 judges “Yes” at the point of time when one of the printing material detection sensors 15 detects the printing base material. In this case, the printing apparatus 100 displays a message on the display part 4, giving an instruction to move the printing base material which is not detected by the printing material detection sensor 15 in the (+Y) direction and stands by until the printing base material is detected by the printing material detection sensor 15. In accordance with the instruction displayed on the display part 4, the operator manually moves the printing base material to the position where it is detected by the printing material detection sensor 15 in the (+Y) direction.

### 2. The Second Preferred Embodiment

Though no detailed discussion has been made in the first preferred embodiment, there is a case where the operator requests double-sided printing on a transparent printing base material. In such a case, since an image printed on one surface (e.g., a front surface) and an image printed on the other surface (e.g., a back surface) are seen, being overlapped, it is necessary to perform more precise positioning of the image printed on one surface and the image printed on the other surface.

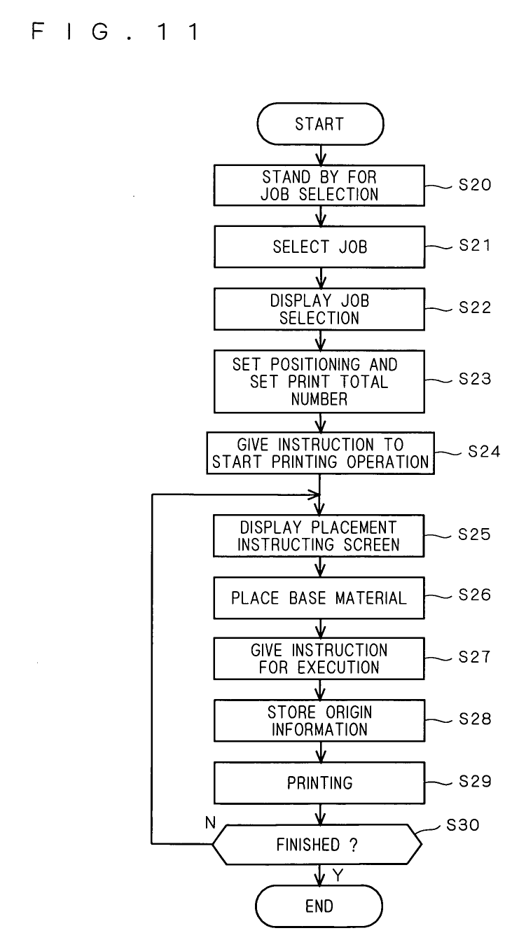

FIG. 10 is a functional block diagram showing a printing apparatus 100a in accordance with the second preferred embodiment. Though discussion has been omitted on the printing apparatus 100 of the first preferred embodiment, the printing apparatus 100a comprises an image data memory 56 and a data processing part 58. In the second preferred embodiment, the constituent elements similar to those in the first preferred embodiment are represented by the same reference signs and description thereof will be omitted as appropriate.

The image data memory 56 is a nonvolatile storage device and mainly stores job information 57. The job information 57 is information on each of printing jobs registered by the operator.

The job information 57 includes, e.g., a job name, the type of printing base material to be used, the type of printing (double-sided printing, plural-page printing, single-sided printing and the like), printing information representing an image, and the like. In the following discussion, the printing job will be sometimes abbreviated simply as “job”.

The data processing part 58 has a function to read required information out from the job information 57 stored in the image data memory 56 into the RAM 50 mainly in accordance with the input from the operation part 3. The information thus read out from the job information 57 includes the left printing information 54, the right printing information 55 and attribute information 59. Though detailed discussion will be omitted, in order to register a new job, in accordance with the input from the operation part 3, the data processing part 58 registers (stores) a record on the new job which is inputted into the image data memory 56.

FIG. 11 is a flowchart showing an operation flow in accordance with the second preferred embodiment. Discussion will be made below on an exemplary case where a job to perform printing on both surfaces of a transparent printing base material 93 is selected.

When a process starts, the control part 5 (the data processing part 58) displays a job list of e.g., table format on the display part 4 and stands by for job selection by the operator (Step S20). Such a display is made on the basis of the job information 57 stored in the image data memory 56. Since a list of already-registered printing jobs is thus displayed on the display part 4, the operator can easily select a job.

Next, the operator selects a job (Step S21). Specifically, the operator manipulates the operation part 3 to input an instruction to specify a desired job out of the list displayed on the display part 4.

In accordance with the operator's instruction, the data processing part 58 reads the information on the selected job out from the job information 57 stored in the image data memory 56 to generate the attribute information 59. The generated attribute information 59 is displayed on the display part 4 as the information on the selected job (Step S22).

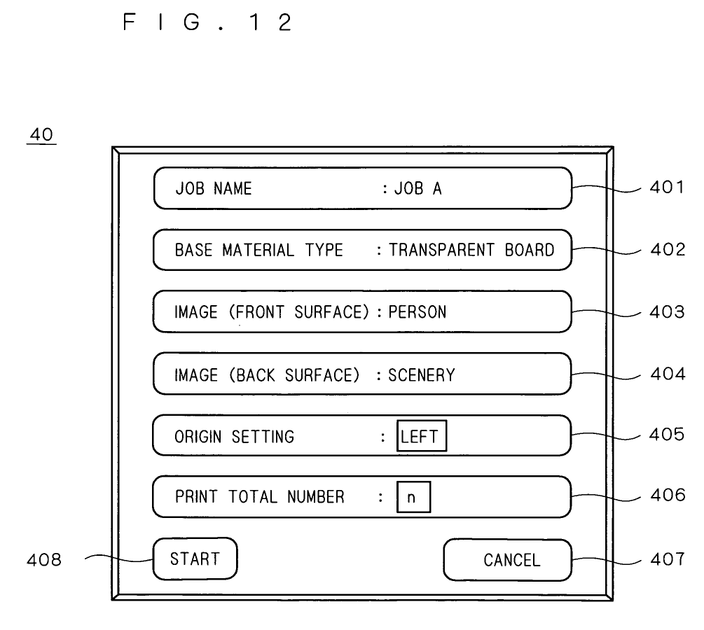

FIG. 12 is a view illustrating a screen 40 displaying the information on the selected job.

On the screen 40 displayed are a job name box 401 indicating a job name of the selected job, a printing base material type display box 402 indicating the type of printing base material 93 on which printing is performed. Further, on the screen 40 displayed are a front-side image display box 403 indicating the type of image, a thumbnail or the like to be printed on one surface (the front surface) of the printing base material 93 and a back-side image display box 404 indicating the type of image, a thumbnail or the like to be printed on the other surface (the back surface) of the printing base material 93.

Furthermore, on the screen 40, as input boxes in which the operator can input, displayed are an origin setting box 405 for setting which reference member should be used for the positioning in the X-axis direction and a print total-number setting box 406 indicating the total number of printing base materials 93 on which printing should be performed. The control part 5 specifies the reference side end in printing on the basis of the information set in the origin setting box 405 by the operator.

In the second preferred embodiment, if “left” is set in the origin setting box 405, the side end disposed on the left side in performing printing on the front surface (i.e., the left side end) is specified as the reference side end, and if “right” is set in the origin setting box 405, the side end disposed on the right side in performing printing on the front surface (i.e., the right side end) is specified as the reference side end.

There may be a case where the information items displayed in these input boxes are inputted in registration of the job and when the screen 40 is displayed, these information items can be simply changed. In the case of FIG. 12, “left” is already set in the origin setting box 405, meaning that the positioning should be made by using the left guide member 16, and “n (natural number)” is already set as the total number to be printed.

Further, in the screen 40, as function buttons, displayed are a cancel button 407 for giving an instruction to perform a cancel operation and a start button 408 for instructing the control part 5 to perform the next step.

In a state where the screen 40 is displayed, the operator inputs the reference member (the left guide member 16 or the right guide member 17) with which the printing base material 93 is brought into contact in its positioning in the origin setting box 405 of the screen 40, to set the positioning. Further, the operator inputs the required number in the print total-number setting box 406 of the screen 40, to set the total number to be printed (Step S23).

Next, the operator manipulates the start button 408 to instruct the control part 5 to perform the next step. Specifically, an instruction to start the printing operation is given to the control part 5 (Step S24). In accordance with the instruction, the control part 5 displays a screen for giving instructions in placement of the printing base material (Step S25).

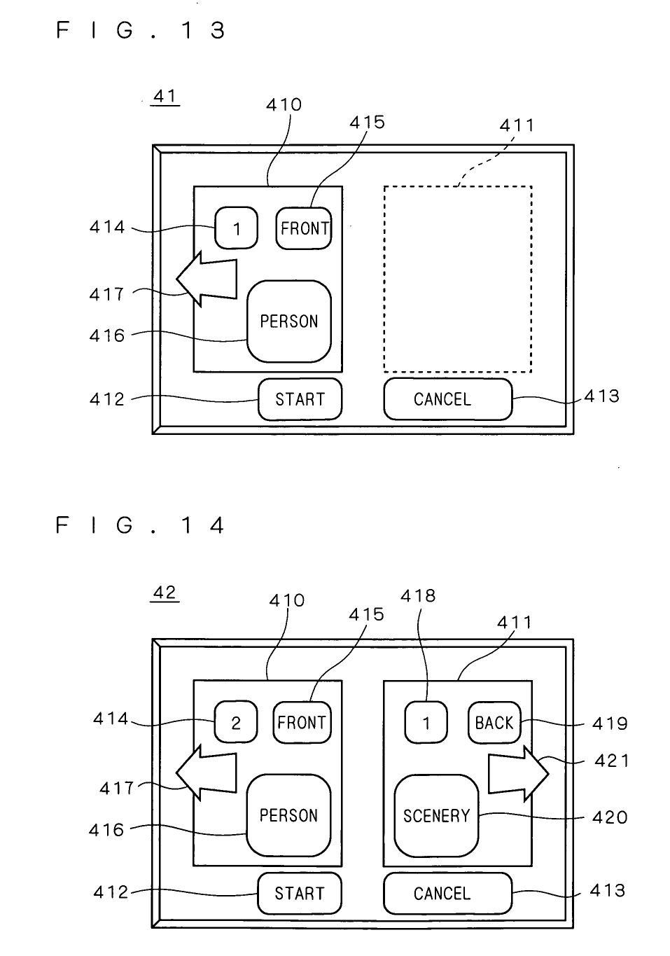

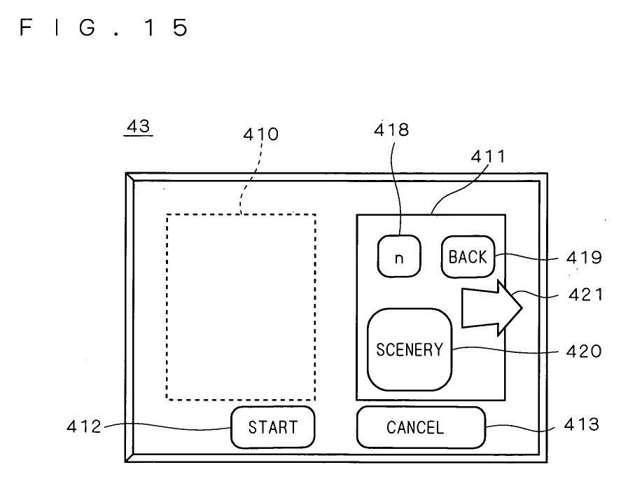

FIGS. 13 to 15 are views each illustrating a screen displaying instructions in placement of the printing base material. A placement instructing screen 41 shown in FIG. 13 is an example of screen displayed when Step S25 is executed for the first time. Further, a placement instructing screen 42 shown in FIG. 14 is an example of screen displayed when Step S25 is executed for the second time. Furthermore, a placement instructing screen 43 shown in FIG. 15 is an example of screen displayed when Step S25 is executed for the last time.

In the placement instructing screens 41 to 43 displayed are an area 410 which is a placement area for a printing base material positioned by the left guide member 16 and an area 411 which is a placement area for a printing base material positioned by the right guide member 17.

As discussed earlier, in the second preferred embodiment, if “left” is set in the origin setting box 405, the left side end is specified as the reference side end in performing printing on the front surface. Therefore, in this exemplary case, the printing base material 93 with its front surface on which printing is performed is displayed in the area 410. On the other hand, the left side end of the printing base material 93 in placement with its front surface facing up becomes the right side end in placement with its back surface facing up. In other words, in a case where printing is performed on the front surface with the left side end as the reference side end, in order to use the same side end as the reference side end also when printing is performed on the back surface, it is necessary to specify the right side end as the reference side end in performing printing on the back surface. Therefore, in this example, the printing base material 93 with its back surface on which printing is performed is displayed in the area 411.

Further, since the placement instructing screen 41 is an exemplary screen displayed when Step S25 is executed for the first time, there is no printing base material 93 displayed in the area 411 (printing base material 93 with its back surface on which printing is performed) and the area 411 is therefore indicated by a broken line. Since the placement instructing screen 42 is an exemplary screen displayed when Step S25 is executed for the second time, both the areas 410 and 411 are indicated by solid lines. Since the placement instructing screen 43 is an exemplary screen displayed when Step S25 is executed for the last time, there is no printing base material 93 displayed in the area 410 (printing base material 93 with its front surface on which printing is performed) and the area 410 is therefore indicated by a broken line.

Thus, by checking the display of the areas 410 and 411, the operator can easily see which area the printing base material 93 should be placed on.

Further, in the placement instructing screens 41 to 43, as function buttons, displayed are a start button 412 for instructing the control part 5 to perform the printing operation and a cancel button 413 for instructing the control part 5 to perform the cancel operation.

In the area 410 of each of the placement instructing screens 41 and 42 displayed are a number display 414 indicating a number for the printing base material 93 to be positioned by the left guide member 16 and a front-back indication display 415 for instructing which surface (front or back) of the printing base material 93 should face up in placement.

In the second preferred embodiment, the number displayed in the number display 414 indicates what number the printing base material 93 is in the selected job. As discussed earlier, since the placement instructing screen 41 is an exemplary screen displayed when Step S25 is executed for the first time, “1” is displayed in the number display 414, indicating the first one. On the other hand, since the placement instructing screen 42 is an exemplary screen displayed when Step S25 is executed for the second time, “2” is displayed, indicating the second one. Thus, by displaying the number display 414, the operator can easily check the progress of the printing operation.

Further, in this exemplary case, as discussed earlier, the printing base material 93 with its front surface on which printing is performed is displayed in the area 410. Conversely, printing is performed on the front surface of the printing base material 93 displayed in the area 410. Therefore, since the printing base material 93 should be placed on the area 410 with its front surface facing up, “front” is displayed in the front-back indication display 415.

Furthermore, in the area 410 displayed are an image display 416 in which the type of image to be printed on the printing base material 93 or a thumbnail is displayed and an arrow 417 indicating which direction the printing base material 93 should be moved for positioning.

In the front-side image display box 403 of FIG. 12, “person” is set as an image to be printed on the front surface. Therefore, in this exemplary case, “person” is displayed in the image display 416. With this display, the operator can easily check the image to be printed on the printing base material 93 to be placed on the area 410.

Further, since the area 410 indicates the placement area for the printing base material to be positioned by the left guide member 16, the arrow 417 is directed leftward. With this arrow, the operator can easily see that the printing base material 93 placed on the area 410 should be moved leftward to come into contact with the left guide member 16 for positioning.

In the area 411 of each of the placement instructing screens 42 and 43 displayed are a number display 418 indicating a number for the printing base material 93 to be positioned by the right guide member 17 and a front-back indication display 419 for instructing which surface (front or back) of the printing base material 93 should face up in placement.

In the second preferred embodiment, the number displayed in the number display 418 indicates what number the printing base material 93 is in the selected job, like in the number display 414. As discussed earlier, since the placement instructing screen 42 is an exemplary screen displayed when Step S25 is executed for the second time, the printing base material 93 to be placed on the area 411, on which printing is performed, is the first printing base material 93. Therefore, “1” is displayed in the number display 418, indicating the first one. On the other hand, since the placement instructing screen 43 is an exemplary screen displayed when Step S25 is executed for the last time, “n” is displayed, indicating the last printing base material 93. Thus, by displaying the number display 418, the operator can easily check the progress of the printing operation.

Further, in this exemplary case, as discussed earlier, the printing base material 93 with its back surface on which printing is performed is displayed in the area 411. Conversely, printing is performed on the back surface of the printing base material 93 displayed in the area 411. Therefore, since the printing base material 93 should be placed on the area 411 with its back surface facing up, “back” is displayed in the front-back indication display 419.

Furthermore, in the area 411 displayed are an image display 420 in which the type of image to be printed on the printing base material 93 or a thumbnail is displayed and an arrow 421 indicating which direction the printing base material 93 should be moved for positioning.

In the back-side image display box 404 of FIG. 12, “scenery” is set as an image to be printed on the back surface. Therefore, in this exemplary case, “scenery” is displayed in the image display 420. With this display, the operator can easily check the image to be printed on the printing base material 93 to be placed on the area 411.

Further, since the area 411 indicates the placement area for the printing base material to be positioned by the right guide member 17, the arrow 421 is directed rightward. With this arrow, the operator can easily see that the printing base material 93 placed on the area 411 should be moved rightward to come into contact with the right guide member 17 for positioning.

When Step S25 is executed and the screen indicating the instructions in placement of the printing base material is displayed, the operator places the printing base material 93 on the adsorption belt 13 in accordance with the screen (Step S26).

Thus, since the operator places the printing base material 93 while checking the screen displayed on the display part 4, it is possible for the operator to accurately place the printing base material 93 on the adsorption belt 13. From the placement instructing screen 41, for example, it can be easily seen that the first printing base material 93 should be brought into contact with the left guide member 16 with its front surface facing up, to be positioned and placed.

When the placement of the printing base material 93 is completed, the operator manipulates the start button 412 to give an instruction for execution to the printing apparatus 100a (Step S27). In accordance with this instruction for execution, the data processing part 58 stores origin information on each printing base material 93 into the image data memory 56 (Step S28), and the printing data generation part 52 generates the printing data to print the image with reference to the reference side end (Step S29) like in the first preferred embodiment.

If the placement instructing screen 41 is displayed, however, since the printing base material 93 is placed only on the left side, the printing data is generated on the basis of only the left printing information 54. On the other hand, if the placement instructing screen 43 is displayed, since the printing base material 93 is placed only on the right side, the printing data is generated on the basis of only the right printing information 55.

When one printing operation is completed, it is judged if all the printing operations are completed (Step S30), and if the printing operations for the total number set in Step S23 are not completed, the process returns to Step S25 and a series of operations are repeated. On the other hand, if all the printing operations are completed, the process is ended.

Thus, in the printing apparatus 100a of the second preferred embodiment, in the case where printing is performed on the front and back surfaces of one printing base material, the instructions are given so that the same side end may serve as the positioning reference both in printing on the front surface and in printing on the back surface.

With respect to the first printing base material 93, for example, in comparison between FIGS. 13 and 14, the side end serving as the positioning reference in printing on the front surface (the side end disposed on the left side) becomes the positioning reference also in printing on the back surface, serving as the reference side end (the side end disposed o the right side).

Therefore, only by placing the printing base material in accordance with the screens displayed on the display part 4, the operator can achieve an excellent image formation with high overlapping accuracy of the images on the front surface and the image on the back surface.

### 3. Variations

Though the preferred embodiments of the present invention have been discussed above, the present invention is not limited to the above-discussed preferred embodiments, but allows various variations.

For example, the left guide member 16 and the right guide member 17 may each consist of a plurality of pins arranged in the Y-axis direction. Further, the left guide member 16 and the right guide member 17 may each consist of a plurality of projections (pins) projected from the adsorption belt 13. In this case, the left guide member 16 and the right guide member 17 move in the Y-axis direction with rotation of the adsorption belt 13. In other words, the reference member may have any shape and does not necessarily have to be fixed only if it has a structure to allow each of a plurality of printing base materials to be positioned in the X-axis direction.

Furthermore, the left guide member 16 and the right guide member 17 may each have a structure like an adjustable width mechanism to allow its position to be changeable in the X-axis direction. In a case where the intervals among a plurality of printing base materials become wide, such as in the case where only two printing base materials of sufficiently small size as compared with the size of the adsorption belt 13 in the X-axis direction are placed, a needless moving distance of the printing head 20 increases. In such a case, the positioning of the printing base materials may be performed after narrowing the distance between the left guide member 16 and the right guide member 17. In the preferred embodiments, since the origin position of an image to be printed on each printing base material is determined in accordance with the position of the reference member, only if the distance changed by narrowing (the moving distance of the reference members) can be detected, the respective images to be printed on the printing base materials are not misaligned. This reduces the printing time. In other words, the reference members have only not to be moved in the X-axis direction when the printing base materials are positioned on the adsorption belt 13 in the X-axis direction.

In the above preferred embodiments, the positioning of the printing base materials in the transfer direction is performed by the printing material detection sensor 15, the transfer control part 51 and the motor 12. The positioning, however, may be performed by bringing the tip portions of the printing base materials into contact with some members (e.g., positioning pins or guide members). In this case, it is possible to perform the positioning in the Y-axis direction without any complicated control. It is preferable, however, that the members should have a structure to be escapable as appropriate by adopting an up-and-down moving mechanism, a removable system or the like in order not to interfere with the transfer of the printing base materials.

Further, the number of a plurality of printing base materials is not limited to two. If three printing base materials are held, for example, a structure in which a reference member to be brought into contact with the printing base material disposed at the center is lowered from an upper portion to a predetermined position may be adopted. Alternatively, as such a reference member, an adapter structure which can be easily detached may be adopted.

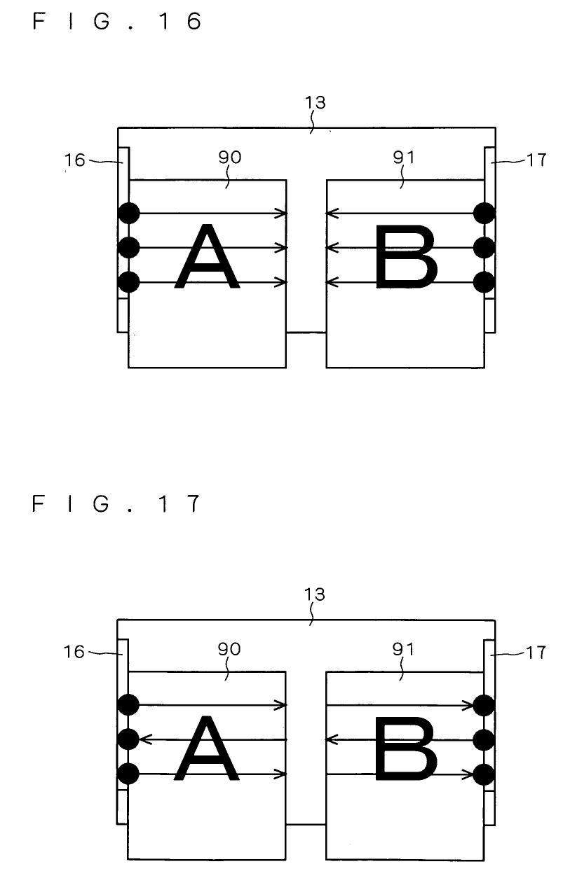

Furthermore, the order of drawing (scanning) by the printing head 20 is not limited to the order shown in the above preferred embodiments. FIGS. 16 and 17 are views each showing a variation of drawing order of the printing head 20. FIG. 16 shows an exemplary case where a scan is sequentially performed from the side of the reference side end in each of the printing base materials 90 and 91. On the other hand, FIG. 17 shows another exemplary case where a scan is performed, for example, from the left side in odd rows and from the right side in even rows. In the case of FIG. 17, the travel time of the printing head 20 can be reduced. The change of the drawing order may be achieved by changing the order of storing the image data into the data buffer 25 or by changing the order of reading the data out from the data buffer 25.

Though the left printing information 54 and the right printing information 55 are inputted from the operation part 3 in the above discussion, these information 54 and 55 may be acquired, for example, via a network or may be read out from a portable recording medium such as a CD-ROM.

The process steps shown in the above preferred embodiments are examples, and the details and the order of steps are not limited to those shown above. In other words, the details and the order of steps may be changed as appropriate only if the same effect can be produced. There may be a case, for example, where the right printing information 55 is first transferred to the data buffer 25 and then the left printing information 54 is transferred thereto.

Though the functional blocks (the transfer control part 51 and the printing data generation part 52) of the above preferred embodiments are implemented by software in the above discussion, part or the whole of these functional blocks may be implemented by dedicated logic circuits, i.e., by hardware.

In the second preferred embodiment, though only the first printing base material 93 is placed in the first printing in the above discussion, if n is two or more, there may be a construction where printing on the front surface of the first printing base material 93 and printing on the back surface of the n-th printing base material 93 are simultaneously performed.

Further, the number displays 414 and 418 of the second preferred embodiment may also display the total number to be printed at the same time. For example, the print number/the total number (“1/n” in this case) may be displayed.

### 4. The Third Preferred Embodiment

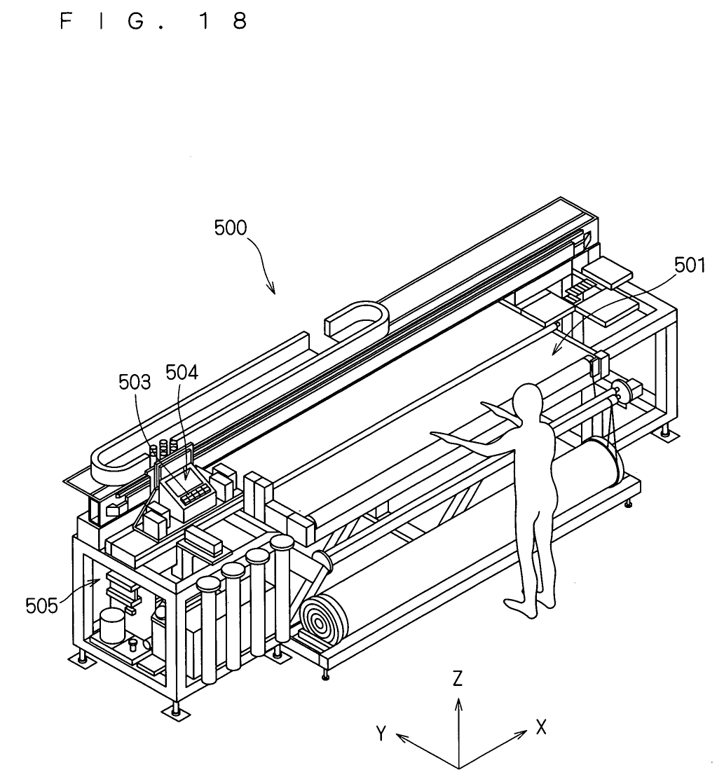

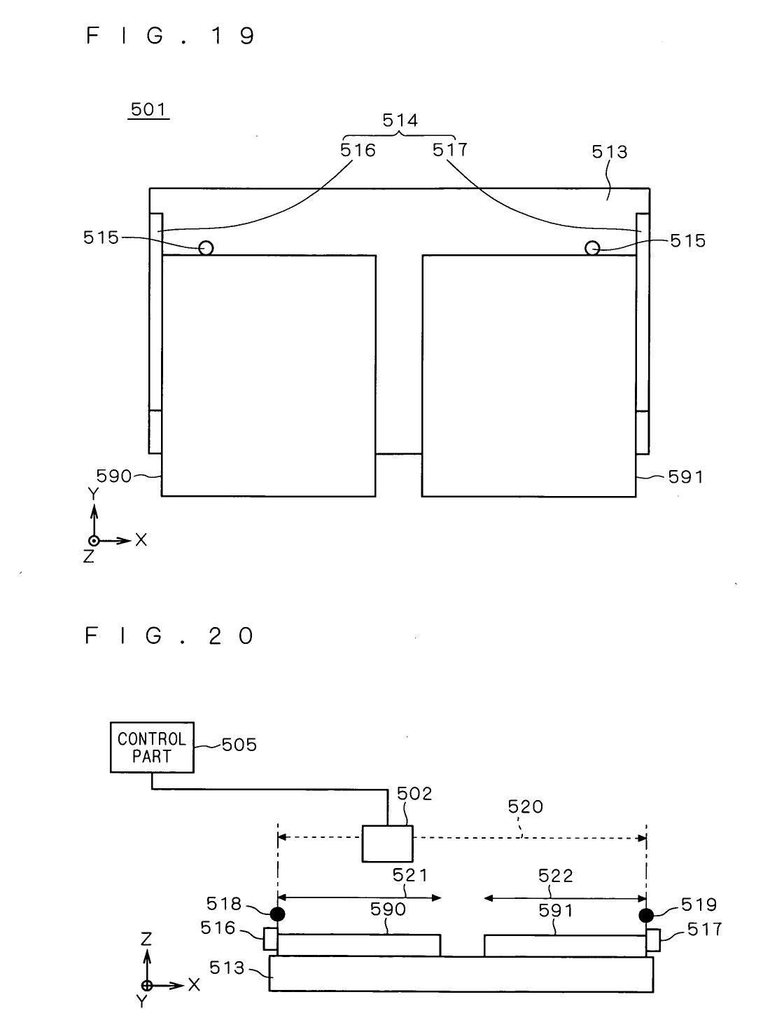

FIG. 18 is a diagrammatic perspective view showing a printing apparatus 500 in accordance with the third preferred embodiment. FIG. 19 is a plan view showing a manner where two printing base materials 590 and 591 are placed on a holding mechanism 501 at the same time. FIG. 20 is a side elevation showing the manner where two printing base materials 590 and 591 are placed on the holding mechanism 501 at the same time. In FIG. 18, though the Z-axis direction is a vertical direction and the XY plane is a horizontal plane for convenience of illustration and discussion, they are defined so for convenience to grasp the positional relation and the directions discussed below are not limited to those. Further, in FIG. 18, an enclosure of the printing apparatus 500 is omitted as appropriate.

The relatively large printing apparatus 500 comprises the holding mechanism 501, a printing head 502, an operation part 503, a display part 504 and a control part 505.

The holding mechanism 501 comprises an adsorption belt 513 and an arrangement reference part 514 and is capable of holding the two printing base materials 590 and 591 at the same time as shown in FIGS. 19 and 20. Though discussed later in detail, the printing apparatus 500 has a construction to print an image on the printing base materials 590 and 591.

The adsorption belt 513 runs between a pair of transfer rollers (not shown) arranged so that the rotation axis thereof is the X axis. The pair of transfer rollers are rotated by a motor, to thereby rotate the adsorption belt 513 in a predetermined direction.

An upper side of the adsorption belt 513 is a plane on which the printing base materials in parallel to the XY plane can be placed. In the printing apparatus 500, an operator places the printing base materials on the adsorption belt 513 for supply of the printing base materials.

The adsorption belt 513 of the third preferred embodiment has a size of about 2.5 m in the X-axis direction, thereby allowing a relatively large printing base material to be placed thereon. The adsorption belt 513 also allows a plurality of relatively small printing base materials 590 and 591 to be placed thereon at the same time. The printing base materials 590 and 591 are not limited to paper but may be cloth, a panel or the like, and not limited to have a rectangular shape but may be rolled up.

The printing base materials placed on the adsorption belt 513 are transferred in the Y-axis direction by rotation of the adsorption belt 513. Therefore, the transfer direction of the printing base materials in the printing apparatus 500 is a direction along the Y axis.

Further, the adsorption belt 513 is provided with an infinite number of holes which are not shown and thereby has a function to adsorb the printing base materials placed thereon to hold them on a predetermined position. Thus, the adsorption belt 513 has a function to hold the printing base materials and a function to transfer the printing base materials held (placed) thereon.

The arrangement reference part 514 has a left guide member 516 and a right guide member 517. Though discussed later, the arrangement reference part 514 has a function to position a plurality of printing base materials placed on the adsorption belt 513 in a direction (X-axis direction) orthogonal to the transfer direction (Y-axis direction) of the printing base materials.

The left guide member 516 and the right guide member 517 are separately disposed and fixed on both sides along the transfer direction so as to be positioned on desired positions in the X-axis direction with respect to the adsorption belt 513. In other words, the left guide member 516 and the right guide member 517 are fixed oppositely to each other in the X-axis direction and the printing base materials transferred by the adsorption belt 513 pass (are transferred) between the left guide member 516 and the right guide member 517.

The left guide member 516 and the right guide member 517 come into contact with different ones out of a plurality of printing base materials. In more detail, the left guide member 516 comes into contact with the left side end of the printing base material 590 placed on the left side of the adsorption belt 513 and the right guide member 517 comes into contact with the right side end of the printing base material 591 placed on the right side of the adsorption belt 513.

With this arrangement, the printing base material 590 is positioned by the left guide member 516 in the X-axis direction with reference to the position of a left origin 518 in the X-axis direction as shown in FIG. 20. The printing base material 591 is positioned by the right guide member 517 in the X-axis direction with reference to the position of a right origin 519 in the X-axis direction as shown in FIG. 20.

The printing material detection sensors 515 schematically shown in FIG. 20 are actually disposed above the adsorption belt 513 and detect that the printing base material placed on the adsorption belt 513 reaches a desired position in the Y-axis direction. A detection result of the printing material detection sensor 515 is transmitted to the control part 505 and then used for e.g., control of the motor to rotate the adsorption belt 513 and the like, though detailed discussion is omitted.

The printing head 502 shown in FIG. 20 forms an image on the printing base materials held by the holding mechanism 501 on the basis of the control of the control part 505. Though the printing head 502 of the third preferred embodiment adopts an inkjet system using a UV ink, naturally, the printing head 502 is not limited to that. Further, the number of printing head 502 is not limited to one.

The printing head 502 is movable to and fro in the X-axis direction by a not-shown driving mechanism. As the printing head 502 moves in the X-axis direction, an area indicated by the broken-line arrow 520 becomes a drawing area (an area in which an image can be formed) of the printing head 502.

As can be clearly seen from FIG. 20, the drawing area of the printing head 502 indicated by the broken-line arrow 520 is so set as to include respective drawing areas of the printing base materials 590 and 591 which are indicated by the solid-line arrows 521 and 522. Therefore, the printing head 502 can form an image on each of the printing base materials 590 and 591 placed at the same time.

Further, as discussed earlier, the printing base materials can be moved by the adsorption belt 513 in the Y-axis direction. Therefore, since the printing head 502 moves in the X-axis direction and the printing base materials are transferred in the Y-axis direction, the printing head 502 can discharge ink onto any position of the printing base materials (more specifically, any position in the XY plane).

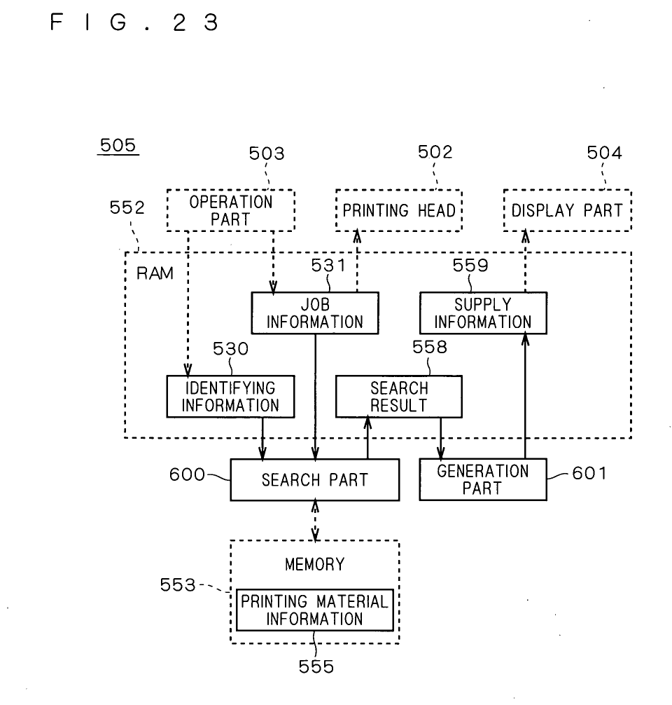

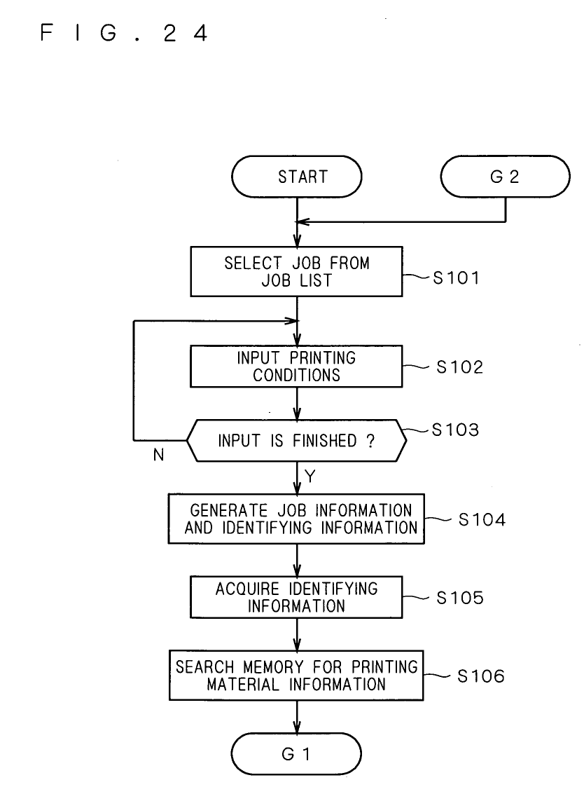

The operation part 503 consists of various buttons, keys, a mouse, a touch panel and the like and is manipulated by the operator in order to input instructions to the printing apparatus 500. In the third preferred embodiment, especially, identifying information 530 (in FIG. 22) for identifying each of the printing base materials to be supplied to the printing apparatus 500 and job information 531 (in FIG. 23) indicating the details of a printing operation and other various information are inputted from the operation part.

The display part 504 corresponds to a general-type liquid crystal display (LCD), lamp and the like and is controlled by the control part 505 to display various data to the operator. In the third preferred embodiment, especially, the display part 504 displays supply information 559 (in FIG. 23) on each of the printing base materials to be supplied to the printing apparatus 500.

FIG. 21 is a bus wiring diagram of the printing apparatus 500. The control part 505 is connected to the constituent elements of the printing apparatus 500 such as the printing head 502, the operation part 503 and the display part 504 with bus wires. Further, the control part 505 comprises a CPU 550, a read-only ROM 551, a RAM 552 which is mainly used as a temporary working area of the CPU 550 and a memory 553 which is a nonvolatile storage medium.

The CPU 550 reads a program 554 stored in the ROM 551 and executes it to perform computation on various data stored in the RAM 552 and the memory 553. Thus, the printing apparatus 500 comprises the CPU 550, the ROM 551, the RAM 552 and the memory 553, to have a constitution as a general-type computer.

The memory 553 stores printing material information 555.

FIG. 22 is a view illustrating a data structure of the printing material information 555. The printing material information 555 forms a database of printing base materials and one record of the printing material information 555 is generated for each printing base material. The printing material information 555 has the identifying information 530, reference side end information 556 and image information 557 as its attributes, and these information are stored on each printing base material.

The reference side end information 556 is information for specifying a side end serving as a positioning reference among a plurality of side ends of a printing base material. In the third preferred embodiment, either one of the left side end and the right side end serves as a reference side end. Further, the image information 557 is information on an image formed on a printing base material and includes e.g., a print position (front surface or back surface, or the like) a thumbnail image of the formed image, print date and time, and the like.

FIG. 23 is a view showing a functional block of the control part 505 together with data flow. A search part 600 and a generation part 601 shown in FIG. 22 are functional blocks which are implemented mainly by an operation of the CPU 550 in accordance with the program 554.

The search part 600 searches the memory 553 for the printing material information 555 on the basis of the identifying information 530 inputted from the operation part 503, and generates a search result 558 on the basis of a result of the search and outputs it to the RAM 552. The search result 558 generated when the identifying information 530 corresponding to the identifying information 530 serving as a search key is found in the printing material information 555 is the identifying information 530 and the reference side end information 556 and the image information 557 which are associated with the identifying information 530.

The search part 600 also generates the reference side end information 556 and the image information 557 of the printing base material (the identifying information 530) on the basis of the result of the search and the job information 531 and registers these information into the printing material information 555 as a new record. In other words, the search result 558 generated when the identifying information 530 corresponding to the identifying information 530 serving as the search key is not found in the printing material information 555 is information indicating that the identifying information 530 is not found.

The job information 531 is information on printing conditions for the printing base material identified by the identifying information 530 and inputted mainly by the operator who manipulates the operation part 503. The printing information indicating an image to be printed (e.g., raster data) and the like is registered in the memory 553 in advance and determined when the operator manipulates the operation part 503 to select one from the job list. In FIG. 23, however, for convenience of illustration, the printing information and the like are included in the job information 531 and inputted from the operation part 503. The printing information registered in the memory 553 in advance may be inputted via a network or from other recording media (CD-ROM and the like). In other words, these information constituting the job information 531 do not necessarily have to be inputted from the operation part 503.

The generation part 601 generates the supply information 559 of a printing base material in accordance with the search result 558. The supply information 559 is information to instruct the operator who supplies the printing base material on how the printing base material should be supplied. The supply information 559 generated by the generation part 601 is displayed on the display part 504, being outputted to the operator. In other words, in the printing apparatus 500, the display part 504 which is an output device and the control part 505 which is a computer constitute a device for assisting the operator in supplying the printing base materials.

The above is discussion on the constitution and function of the printing apparatus 500 of the third preferred embodiment. Next, discussion will be made on a method of forming an image on a printing base material in the printing apparatus 500.

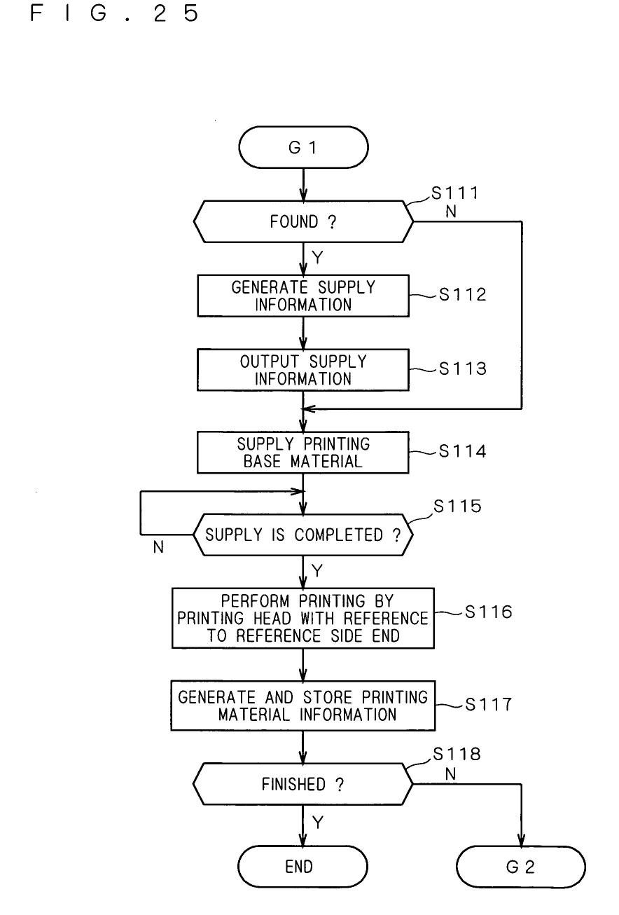

FIGS. 24 and 25 are flowcharts showing a printing method using the printing apparatus 500.

First, the operator manipulates the operation part 503 to select a job to be performed from the job list displayed on the display part 504 (Step S101).

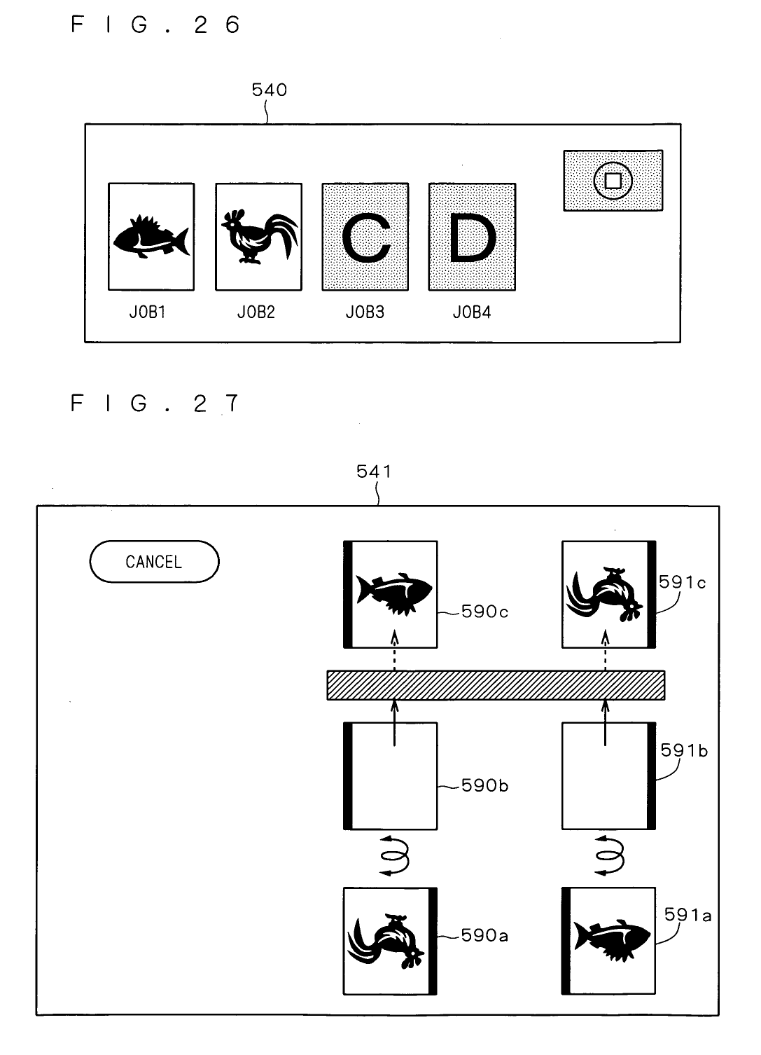

FIG. 26 is a view illustrating an example of job list selection screen 540 displayed on the display part 504. When Step S101 is executed, on the display part 504, for example, a screen like the job list selection screen 540 is displayed and the operator can thereby easily see the jobs which are already registered and easily select a required job.

When the job selection in Step S101 is finished, the operator inputs printing conditions in the selected job (Step S102). The printing conditions inputted in Step S102 include the identifying information 530 of the printing base material on which an image is formed in the selected job. Specifically, the operator inputs the identifying information 530 of the printing base material to be supplied to the printing apparatus 500 as one of the printing conditions. Further, if a plurality of printing base materials are to be supplied at the same time to perform the printing operation, a plurality of jobs are selected in Step S101 and a plurality of identifying information 530 are inputted in Step S102. Hereafter, discussion will be made on a case where printing is performed on the printing base materials 590 and 591.

When the operator inputs the instruction indicating that the input of the printing conditions is completed, the printing apparatus 500 judges “Yes” in Step S103 and generates the job information 531 and the identifying information 530 on each of the printing base materials 590 and 591 (Step S104).

After generation of the job information 531 and the identifying information 530, the search part 600 acquires the generated identifying information 530 from the RAM 552 (Step S105), and searches the memory 553 for the respective printing material information 555 on the printing base materials 590 and 591 by using the acquired respective identifying information 530 as the search keys (Step S106).

If no printing operation is performed on the printing base materials 590 and 591 and no image is formed on the printing base materials 590 and 591, the information on the printing base materials 590 and 591 are not registered in the memory 553 yet. In this case, the search part 600 can not acquire the respective printing material information 555 on the printing base materials 590 and 591 and then generates the search result 558 indicating that no identifying information 530 is found. In accordance with the search result 558, the printing apparatus 500 judges “No” in Step S111 and skips Steps S112 and S113.

Even if the Steps S112 and S113 are skipped, however, the information on the supply of the printing base materials 590 and 591 may be displayed on the display part 504. Among the information displayed in such a case are e.g., a message instructing the operator to supply unused printing base materials 590 and 591 or information on whether the specifications (types, sizes and the like) of the printing base materials 590 and 591 are judged to be suitable for the selected job or not, the procedure for the reliable positioning of the printing base materials 590 and 591 in the printing apparatus 500, and the like.

On the other hand, if the printing operation is performed on the printing base materials 590 and 591, the information on the printing base materials 590 and 591 are already registered in the memory 553. In this case, the search part 600 acquires the respective printing material information 555 on the printing base materials 590 and 591 from the memory 553 and generates the respective search results 558 on the printing base materials 590 and 591. In accordance with the search results 558, the printing apparatus 500 judges “Yes” in Step S111. Therefore, the generation part 601 generates the supply information 559 on the basis of the search results 558 (Step S112) and the display part 504 outputs the generated supply information 559 to the screen (Step S113).

Next, the operator supplies the printing base materials to the printing apparatus 500 while referring to the screen display on the display part 504 (Step S114). When Step S114 is executed, if Step S113 has been executed, the operator supplies the printing base materials while checking the supply information 559.

FIG. 27 is a view illustrating a screen 541 displaying the supply information 559. FIG. 27 shows an exemplary case where a front image (sea bream) and a back image (chicken) are printed on the two printing base materials 590 and 591.

Seeing an image 590a on the screen 541, the operator sees that an image of chicken should be formed on the back surface of the printing base material 590. Further, considering the image of chicken and the direction of arrow (the transfer direction), the operator can easily find which of the upper and lower ends (end portions formed in a direction along the X axis) of the printing base material 590 should be directed forward as the material is supplied. In other words, the operator can easily find the directions of the upper and lower ends of the printing base material 590. The images of sea bream and chicken are displayed in accordance with the supply information 559 generated on the basis of the image information 557 (the thumbnail image) stored in the printing material information 555.

Further, the right side end of the image 590a is drawn thickly, being emphasized. It can be thereby found that the side end serves as the reference side end in the previous printing operation on the printing base material 590 and the image (chicken) is formed with reference to the side end. Therefore, the operator can easily find that the printing base material 590 should be supplied with its side end on the right side in the image 590a being brought into contact with the arrangement reference part 514 and that the printing base material 590 should be so placed on the left side of the adsorption belt 513 as to come into contact with the left guide member 516. In other words, the operator can easily find that directions of the left and right sides of the printing base material 590. Which of the left and right side ends should be emphasized in display is determined in accordance with the supply information 559 generated on the basis of the reference side end information 556 stored in the printing material information 555.

Thus, since the respective supply information 559 of the printing base materials 590 and 591 to be supplied to the printing apparatus 500 are displayed on the display part 504 of the printing apparatus 500, the operator can supply the printing base materials 590 and 591 without any mistake.

When the supply operation by the operator is completed, the printing apparatus 500 judges “Yes” in Step S115 and the printing head 502 prints the images with reference to the reference side ends of the printing base materials 590 and 591 (Step S116). Specifically, the printing head 502 prints the image on the printing base material 590 in contact with the left guide member 516 with its left side end as its origin and prints the image on the printing base material 591 in contact with the right guide member 517 with its right side end as its origin.

With this operation, the side end serving as the reference side end when the image of chicken is printed serves as the reference side end also when the image of sea bream is printed. In other words, even if the images for the double-sided printing, the image for the overlap printing or the like are printed in a plurality of times, since the printing apparatus 500 always forms the image with reference to the same side end, it is possible to prevent the images formed by a plurality of printing operations from being misaligned.

When the printing operation is completed, the search part 600 generates the printing material information 555 on the basis of the identifying information 530 and job information 531 and stores it into the memory 553 (Step S117). In other words, with respect to the printing base material which is not registered in the printing material information 555 yet, a new record is registered and with respect to the printing base material which is already registered in the printing material information 555, its content is updated.

Thus, in the printing apparatus 500, since the printing material information 555 on each printing base material is stored in the memory 553 and the search part 600 searches the memory 553 for the printing material information 555 on the printing base material to be supplied to the printing apparatus 500 on the basis of the identifying information 530 for identifying the printing base material and the generation part 601 generates the supply information 559 on the printing base material in accordance with the search result and outputs the supply information 559 to the display part 504, it is possible to supply the printing base material without any mistake by performing the supply operation in accordance with the screen displayed on the display part 504. Therefore, the load for supplying the printing base materials can be reduced.

Further, since the printing material information 555 has the reference side end information 556 indicating the reference side end which serves as the positioning reference in supplying the printing base material as its attribute, even if the reference side ends are different depending on the printing base materials, the optimum supply information 559 can be generated and displayed. Therefore, the load for supplying the printing base materials never grows.

Furthermore, since the printing head 502 forms an image on a printing base material with reference to the reference side end included in the printing material information 555 on the printing base material, the position accuracy in image formation is improved.

### 5. Variations

Though the preferred embodiment of the present invention has been discussed above, the present invention is not limited to the above-discussed preferred embodiment, but allows various variations.

In the above preferred embodiment, for example, the functional blocks (the search part 600 and the generation part 601) included in the printing apparatus 500 are implemented by an operation of the CPU 550 in accordance with the program 554, i.e., by software. Part or the whole of these functional blocks, however, may be implemented by dedicated logic circuits, i.e., by hardware.

The process steps shown in the above preferred embodiment are examples, and the details and the order of steps are not limited to those shown above. In other words, the details, the order of steps and the like may be changed as appropriate only if the same effect can be produced.

While the invention has been shown and described in detail, the foregoing description is in all aspects illustrative and not restrictive. It is therefore understood that numerous modifications and variations can be devised without departing from the scope of the invention.

What is claimed is:

1. A printing apparatus for performing printing on printing base materials, comprising:
a holding device for holding a plurality of printing base materials at the same time; and
an image forming part for forming an image on said plurality of printing base materials held by said holding device,
wherein said holding device comprises
a base on which a plurality of printing base materials are placed at the same time; and
an arrangement reference part for positioning said plurality of printing base materials placed on said base in a direction orthogonal to a transfer direction of said printing base materials, and
said arrangement reference part has a plurality of reference members which come into contact with different ones out of said plurality of printing base materials.

2. The printing apparatus according to claim 1, further comprising
a specifying part for specifying a side end of each of said plurality of printing base materials held by said holding device, with which one of said reference members comes into contact, as a reference side end,
wherein said image forming part forms an image on each of said plurality of printing base materials with reference to said reference side end specified by said specifying part.

3. The printing apparatus according to claim 1, further comprising
a positioning part for positioning said plurality of printing base materials placed on said base in said transfer direction of said printing base materials.

4. The printing apparatus according to claim 1, further comprising
a detection part for detecting that positioning of said plurality of printing base materials held by said base is completed,
wherein said image forming part starts forming an image in accordance with a detection result of said detection part.

5. The printing apparatus according to claim 2, wherein
said printing base material is a transparent printing base material with its both surfaces on which images are individually formed, and
said specifying part specifies a side end on the same side as said reference side end which is a reference in image formation on one surface of said printing base material, as a reference side end in image formation on the other surface.

6. The printing apparatus according to claim 5, wherein
said specifying part displays said reference side end on a screen.

7. A holding device for holding a plurality of printing base materials at the same time, comprising:
a base on which a plurality of printing base materials are placed at the same time; and
an arrangement reference part for positioning said plurality of printing base materials placed on said base in a direction orthogonal to a transfer direction of said plurality of printing base materials,
wherein said arrangement reference part has a plurality of reference members which come into contact with different ones out of said plurality of printing base materials.

8. The holding device according to claim 7, further comprising
a positioning part for positioning said plurality of printing base materials placed on said base in said transfer direction of said printing base materials.

9. A printing method of forming an image while holding a plurality of printing base materials, comprising the steps of:
(a) placing a plurality of printing base materials on a base;
(b) bringing said plurality of printing base materials placed on said base into contact with different reference members and positioning said plurality of printing base materials in a direction orthogonal to a transfer direction of said printing base materials; and
(c) forming an image on said plurality of printing base materials positioned on said base.

10. The printing method according to claim 9, further having the step of
(d) specifying a side end of each of said plurality of printing base materials placed on said base, with which one of said reference members comes into contact, as a reference side end before execution of said step (c),
said step (c) forming an image on each of said plurality of printing base materials with reference to said reference side end specified in said step (d).

11. A printing apparatus for printing an image on a printing base material, comprising:
a storage part for storing printing material information for each printing base material;
a search part for searching said storage part for the printing material information of a printing base material to be supplied to said printing apparatus on the basis of identifying information for identifying said printing base material;
a generation part for generating supply information of said printing base material in accordance with a search result of said search part;
an output part for outputting said supply information generated by said generation part; and
an image forming part for forming an image on said printing base material.

12. The printing apparatus according to claim 11, wherein
said image forming part forms an image on a printing base material with reference to a reference side end which serves as a positioning reference in supplying said printing base material to said printing apparatus.

13. The printing apparatus according to claim 12, wherein
said printing material information has information indicating a reference side end which serves as a positioning reference in supplying a printing base material, as its attribute.

14. A printing method for printing an image on a printing base material by a printing apparatus, comprising the steps of:
(a) acquiring identifying information for identifying a printing base material on which an image is formed by said printing apparatus;
(b) searching a storage part for printing material information of said printing base material in accordance with said identifying information;
(c) generating supply information of said printing base material when said printing material information of said printing base material is found in said step (b);
(d) outputting said supply information generated in said step (c);
(e) supplying said printing base material to said printing apparatus;
(f) forming an image on said printing base material supplied to said printing apparatus in said step (e); and
(g) storing said printing material information of said printing base material into said storage part.

15. The printing method according to claim 14, wherein
an image is formed on said printing base material with reference to a reference side end which serves as a positioning reference in supplying said printing base material to said printing apparatus in said step (f), and
said printing material information has information indicating said reference side end as its attribute.

16. A program product capable of being executed by a computer, wherein
execution of said program product by said computer causes said computer to function as:
a storage part for storing printing material information for each printing base material;
a search part for searching said storage part for the printing material information of a printing base material to be supplied on the basis of identifying information for identifying said printing base material;
a generation part for generating supply information of said printing base material in accordance with a search result of said search part; and
an output part for outputting said supply information generated by said generation part.
